(19) United States
(12) Patent Application Publication
(10) Pub. No.: US 2006/0214859 A1
(43) Pub. Date: Sep. 28, 2006

(54) Antenna apparatus

(75) Inventor: Nobuhiro Ide, Toyota-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/366,431

(22) Filed: Mar. 3, 2006

(30) Foreign Application Priority Data
Mar. 25, 2005 (JP) 2005-087642

(51) Int. Cl. H01Q 1/32

(52) U.S. Cl. 343/713; 343/895; 343/872

(57) ABSTRACT

An antenna apparatus includes an antenna case and an antenna disposed inside the antenna case. The antenna includes a coil-shaped portion which engages with a securing portion of the antenna case so as to fix the pitch of the coil-shaped portion. The antenna case may be formed of a difficult to deform electrically insulating material. A base end portion of the antenna is connected to a predetermined portion of a substrate mounted inside the antenna case, and a ground connecting portion of the substrate is electrically connected to a rust resistant connecting member which is provided outside the antenna case and is grounded. In a preferred embodiment, the antenna is mounted in a door mirror of a vehicle.

### BACKGROUND OF THE INVENTION

1. Field of the Invention

The present invention relates to an antenna apparatus having an antenna housed inside an antenna case (also referred to as an antenna cover), with a portion of the antenna having the shape of a coil.

2. Description of the Related Art

An example of an antenna apparatus of the type to which the present invention relates is disclosed in Japanese Patent Application Laid-Open (kokal) No. H9-102707. In that document, a coil-shaped portion of an antenna is covered by a flexible heat shrink tube, and the coil-shaped portion which is covered by the heat shrink tube is housed inside an elastic antenna cover.

In the antenna apparatus described in that document, the heat shrink tube is flexible, so there is the possibility of the coil-shaped portion of the antenna vibrating and deforming inside the antenna cover. As a result, there is the possibility of the impedance of the antenna (which greatly affects the antenna performance) varying due to this deformation.

### SUMMARY OF THE INVENTION

The present-invention was made in order to cope with the above-described problem of an existing antenna apparatus. According to the present invention, an antenna apparatus includes an antenna which is housed inside an antenna case, with a portion of the antenna having the shape of a coil. A securing portion which fixes the pitch of the coil-shaped portion of the antenna is provided inside the antenna case.

In the antenna apparatus according to the present invention, the pitch of the coil-shaped portion of the antenna is fixed by the securing portion provided in the antenna case. Therefore, vibration of the coil-shaped portion of the antenna inside the antenna case (which can be a source of noise) is suppressed, and deformation of the coil-shaped portion (which changes the impedance of the antenna) is suppressed. Accordingly, the performance of the antenna can be maintained at a high level.

In carrying out the present invention, the antenna case may be formed from an electrically insulating material which is difficult to deform (such as an ABS resin). By employing such a material for the antenna case, it is possible to effectively suppress deformation of the coil-shaped portion of the antenna. In carrying out the present invention, a base end portion of the antenna may be connected to a predetermined portion of a substrate which is disposed inside the antenna case, and a ground connecting portion of the substrate may be electrically connected to a rust-resistant connecting member which is grounded and which is provided on the exterior of the antenna case. With such a structure, rusting of the connecting member can be suppressed, and a change in the gain of the antenna can be reduced.

The present invention also provides a door-mirror-mounted antenna apparatus for a vehicle. The antenna apparatus includes an antenna housed inside an antenna case disposed inside a door mirror of a vehicle. The antenna includes a coil-shaped portion. A securing portion which fixes the pitch of the coil-shaped portion of the antenna is provided inside the antenna case.

In the door-mirror-mounted antenna apparatus according to the present invention, the pitch of the coil-shaped portion of the antenna is fixed by the securing portion provided inside the antenna case. Therefore, vibration of the coil-shaped portion of the antenna inside the antenna case (which can be a source of noise) is suppressed, and deformation of the coil-shaped portion (which changes the impedance of the antenna) is suppressed. Accordingly, the performance of the antenna can be maintained at a high level.

In carrying out the present invention, a base end portion of the antenna may be connected to a predetermined portion of a substrate mounted in the antenna case, and a ground connecting portion of the substrate may be grounded to the body of the vehicle by a rust-resistant connecting member provided outside the antenna case. With this structure, rusting of the connecting member can be suppressed, and a change in the gain of the antenna can be reduced.

It is also possible to provide a positioning member for the connecting member on the antenna case. With this structure, it is possible to specify the positional relationship between the antenna case which houses the antenna and the connecting member which is grounded to the body of the vehicle. As a result, variations in properties due to mounting errors of the antenna with respect to the connecting member can be suppressed, and the performance of the antenna can be made uniform.

### BRIEF DESCRIPTION OF THE DRAWINGS

Various other objects, features and many of the attendant advantages of the present invention will be readily appreciated as the same becomes better understood by reference to the following detailed description of the preferred embodiment when considered in connection with the accompanying drawings, in which:

FIG. 1 is a front view of an embodiment of an antenna apparatus according to the present invention housed inside a door mirror of a vehicle;

FIG. 2 is an overall perspective view of the antenna apparatus shown in FIG. 1;

FIG. 3 is a perspective view of the left end of the antenna apparatus shown in FIG. 2;

FIG. 4 is a perspective view showing the state in which the upper portion of the antenna case shown in FIG. 3 has been removed;

FIG. 5 is a perspective view showing the relationship between the lower portion of the antenna case and the grounding plate shown in FIG. 4;

FIG. 6 is a front view of the antenna shown in FIG. 4 by itself;

FIG. 7 is a perspective view showing the relationship between the plurality of securing claws formed in the lower portion of the antenna case and the coil-shaped portion of the antenna; and

FIG. 8 is a perspective view of a portion of the lower portion of the antenna case in which are formed the plurality of securing claws shown in FIG. 7.

### DESCRIPTION OF PREFERRED EMBODIMENT

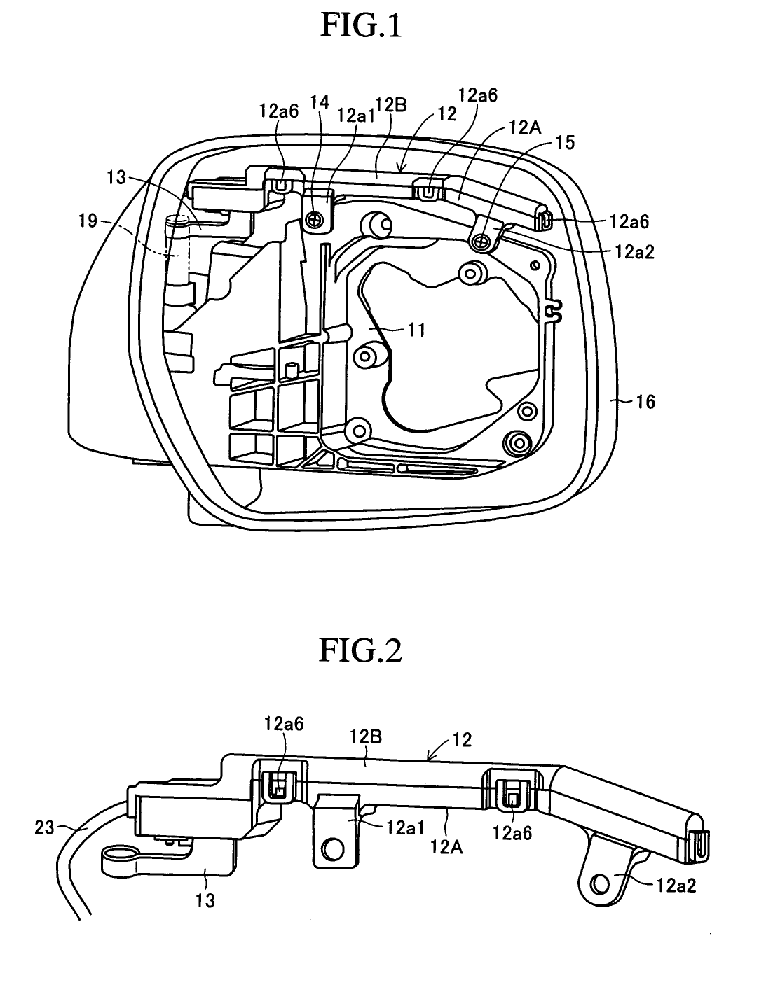

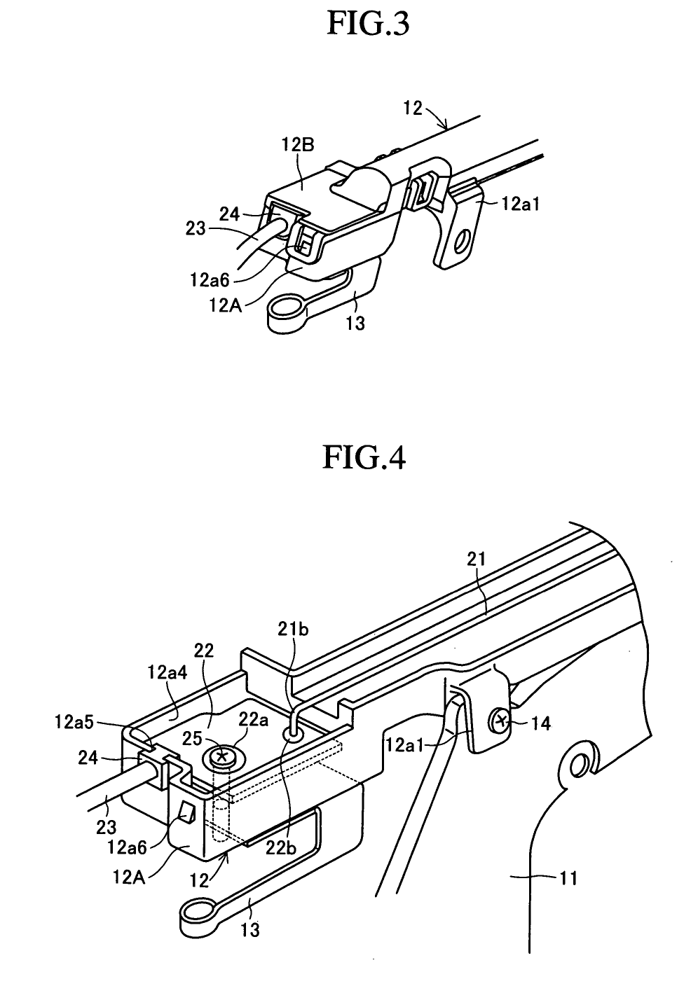

Below, an embodiment of the present invention will be described while referring to the accompanying drawings. FIGS. 1 to 8 illustrate an embodiment of an antenna apparatus according to the present invention housed inside a door mirror of a vehicle, i.e., they illustrate a door-mirror-mounted antenna apparatus. In this embodiment, an antenna case 12 is mounted on a mirror bracket 11 by a pair of screws 14 and 15. The mirror bracket 11 is formed in a prescribed shape from metal, and it is housed inside a door mirror housing 16. In this embodiment, a grounding plate 13 is rotatably connected to a metal shaft 19. The shaft 19 is mounted on and electrically grounded by the body (not shown) of the vehicle. The shaft 19 rotatably supports the mirror bracket 11.

The antenna case 12 comprises a lower portion 12A which is mounted on the mirror bracket 11 and an upper portion 12B which is detachably mounted on the lower portion 12A. Both portions 12A and 12B are made of a difficult to deform electrically insulating material, such as an ABS resin. As shown in FIG. 4, the antenna case 12 houses an antenna 21 and a substrate 22. The grounding plate 13 and a coaxial cable 23 are mounted on the antenna case 12.

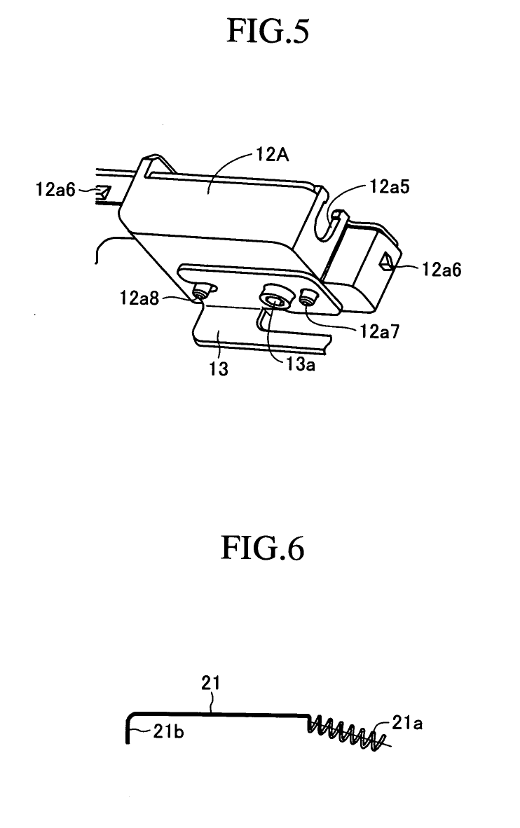

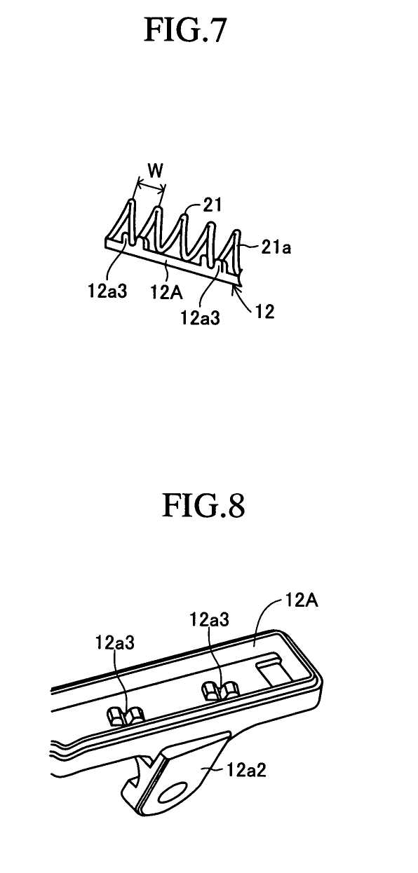

The lower portion 12A of the antenna case 12 has a pair of mounting flanges 12a1 and 12a2 for use in mounting the lower portion 12A on the mirror bracket 11, a plurality of securing claws 12a3 (see FIG. 7 and FIG. 8) for maintaining the pitch W of the coil-shaped portion 21a of the antenna 21 at a prescribed value, a recess 12a4 (see FIG. 4) for housing the substrate 22, and a notch 12a5 (see FIG. 4 and FIG. 5) for receiving a grommet 24 through which the coaxial cable 23 is led to the outside of the antenna case 12.

The lower portion 12A of the antenna case 12 also includes a plurality of projections 12a6 for engaging the upper portion 12B of the antenna case 12 with a snap fit and thereby detachably securing the upper portion 12B to the lower portion 12A. In addition, as shown in FIG. 5, the lower portion 12A has a rotation preventing pin 12a7 for preventing rotation of the grounding plate 13, and a positioning pin 12a8 for positioning the grounding plate 13, whereby the grounding plate 13 is positioned with respect to the lower portion 12A of the antenna case 12.

The grounding plate 13 is a connecting member which can electrically connect a ground connecting portion 22a of the substrate 22 to the body (not shown) of the vehicle. In other words, the grounding plate 13 performs electrical grounding to the body of the vehicle. The grounding plate 13 is disposed on the exterior of the antenna case 12, and it is formed of a rust resistant material such as stainless steel. The grounding plate 13 is connected to the substrate 22 by an electrically conducting screw 25 (see FIG. 4) which threadingly engages with an internally threaded portion 13a of the grounding plate 13 (see FIG. 5), whereby the grounding plate 13 is electrically connected to the ground connecting portion 22a of the substrate 22. The grounding plate 13 is also rotatably and electrically connected to the shaft 19 which is installed on the mirror bracket 11.

The antenna 21 has, at its tip end, a helical coil-shaped portion 21a which is press fit into each of the securing claws 12a3 of the lower portion 12A of the antenna case 12 (see FIG. 6 and FIG. 7). The antenna 21 has, at its base end, an L-shaped portion 21b which is electrically connected to a predetermined portion 22b of the substrate 22 (see FIG. 4 and FIG. 6). The antenna 21 receives a signal from a transmitter which indicates the air pressure sensed by a tire pressure sensor mounted on an unillustrated wheel of the vehicle.

In a door-mirror-mounted antenna apparatus having the above-described structure, the pitch W of the coil-shaped portion 21a of the antenna 21 is fixed at a prescribed value by the plurality of securing claws 12a3 formed in the lower portion 12A of the antenna case 12. Therefore, vibrations (which become a cause of noise) of the coil-shaped portion 21a of the antenna 21 inside the antenna case 12 are suppressed, and deformation (which changes the impedance of the antenna 21) is also suppressed. Accordingly, the performance of the antenna 21 can be maintained at a high level.

In this antenna apparatus, the antenna case 12 is formed of a difficult to deform electrically insulating material (such as an ABS resin). Therefore, it is possible to effectively suppress deformation of the coil-shaped portion 21a of the antenna 21.

In this antenna apparatus, the L-shaped portion 21b at the base end of the antenna 21 is connected to the predetermined portion 22b of the substrate 22 installed inside the antenna case 12, and the ground connecting portion 22a of the substrate 22 is grounded to the body of the vehicle through the rust resistant grounding plate 13 provided on the exterior of the antenna case 12. Therefore, rusting of the grounding plate 13 is prevented, and changes in the gain of the antenna 21 can be suppressed.

In this antenna apparatus, the rotation preventing pin 12a7 and the positioning pin 12a8 are provided on the lower portion 12A of the antenna case 12 to position the grounding plate 13 with respect to the antenna case 12. Therefore, it is possible to specify the positional relationship between the antenna case 12 which houses the antenna 21 and the grounding plate 13 which is grounded to the body of the vehicle. As a result, variations in properties due to mounting errors of the antenna 21 with respect to the grounding plate 13 can be suppressed, and the performance of the antenna 21 housed inside the antenna case 12 can be made uniform.

In the above-described embodiment, the pitch W of the coil-shaped portion 21a of the antenna 21 is fixed at a prescribed value by the plurality of securing claws 12a3 formed in the lower portion 12A of the antenna case 12. However, the pitch W of the coil-shaped portion 21a of the antenna 21 can be adjusted through adjustment of the positions of the securing claws 12a3, whereby the impedance of the antenna 21 can be adjusted.

In the above-described embodiment, the rust resistant grounding plate 13 is used as a connecting member for electrically connecting the ground connecting portion 22a of the substrate 22 to the shaft 19 which is grounded to the vehicle body. However, instead of the grounding plate 13, it is possible to use a grounding wire, for example.

In the above-described embodiment, the pitch W of the coil-shaped portion 21a of the antenna 21 is fixed by a plurality of securing claws 12a3 (the shape and number of which can be suitably varied) formed in the lower portion 12A of the antenna case 12. However, it is possible to carry out the invention while eliminating the plurality of securing claws 12a3. Thus, the present invention is in no way limited to the structure of the above-described embodiment.

What is claimed is:

1. An antenna apparatus comprising an antenna case, and an antenna disposed inside the antenna case and having a coil-shaped portion, the antenna case including a securing portion for fixing the pitch of the coil-shaped portion of the antenna.

2. An antenna apparatus as claimed in claim 1, wherein the antenna case is formed of a difficult to deform electrically insulating material.

3. An antenna apparatus as claimed in claim 1, wherein a base end portion of the antenna is connected to a predetermined portion of a substrate which is disposed inside the antenna case, and a ground connecting portion of the substrate is connected to a rust resistant connecting member which is provided outside the antenna case and is grounded.

4. An antenna apparatus as claimed in claim 2, wherein a base end portion of the antenna is connected to a predetermined portion of a substrate which is disposed inside the antenna case, and a ground connecting portion of the substrate is connected to a rust resistant connecting member which is provided outside the antenna case and is grounded.

5. A door-mirror-mounted antenna apparatus comprising an antenna case mounted in a door mirror of a vehicle, and an antenna disposed inside the antenna case and having a coil-shaped portion, the antenna case including a securing portion for fixing the pitch of the coil-shaped portion of the antenna.

6. A door-mirror-mounted antenna apparatus as claimed in claim 5, wherein a base end portion of the antenna is connected to a predetermined portion of a substrate which is disposed inside the antenna case, and a ground connecting portion of the substrate is grounded to a body of the vehicle via a rust resistant connecting member which is provided outside the antenna case.

7. A door-mirror-mounted antenna apparatus as claimed in claim 6, further comprising positioning means, provided within the antenna case, for positioning the connecting member.
